(19) United States
(12) Patent Application Publication
(10) Pub. No.: US 2016/0169792 A1
(43) Pub. Date: Jun. 16, 2016

(54) A Photo-Alignment Characteristics Testing Method, A Device And A System

(71) Applicant: Shenzhen China Star Optoelectronics Technology Co. Ltd., Shenzhen, Guangdong (CN)

(72) Inventor: Yanjun SONG, Shenzhen, Guangdong (CN)

(73) Assignee: Shenzhen China Star Optoelectronics Technology Co. Ltd., Shenzhen, Guangdong (CN)

(21) Appl. No.: 14/433,645

(22) PCT Filed: Dec. 17, 2014
(86) PCT No.: PCT/CN2014/094058

§ 371 Date: Apr. 4, 2015

(30) Foreign Application Priority Data
Dec. 12, 2014 (CN) 2014107704636

(51) Int. Cl. G01N 21/21

(52) U.S. Cl. CPC G01N 21/21; G01N 2201/0683

(57) ABSTRACT

The present invention provides a photo-alignment characteristics testing method, a device and a system, wherein, the method comprises: forming a optical combination comprising a first optical device and a second optical device, the first optical device comprises at least a polarizer film, and the second optical device is a pre-tested material with a photocurabled alignment film disposed in; changing an included angle between an optical axis of the polarizer film in the first optical device and an optical axis of the alignment film in the second optical device simultaneously when lighting through the optical combination; and measuring light after lighting through the optical combination to obtain light intensities from different included angle situations and then to obtain photo-alignment characteristics of the alignment film. Via aforementioned method, the present invention can apply polarized absorption spectra at operation detections during panel manufacturing process to solve a technical problem of limited substrate types to detecting methods.

### FIELD OF THE INVENTION

The invention relates to a mobile terminal technical field, in particular to a photo-alignment characteristics testing method, a device and a system.

### BACKGROUND OF THE INVENTION

In present technologies, by illuminated alignment films or alignment layers (hereinafter referred to as photo-alignment film) with polarized ultraviolet to have photochemical reactions with polymers parallel to a photo-polarization direction occurred, to have anisotropic distribution happened on a film surface, and then to induce permutations of liquid crystal molecules. The alignment procedures is so-called photo-alignment technologies, and the alignment is broadly applied in alignments and etc. of liquid crystal alignment films comprised by liquid crystal panel elements of liquid crystal display panels.

Present photo-alignment technical testing method usually divides into single-film test and cell test, wherein, the single-film test generally comprises polarized absorption spectra and phase delay measurement, and cell test comprises optical characteristic measurement.

In general, operation dections during panel manufacturing process is critically important, but a present operation detection is phase delay measurement for photo-alignment technology, and it is utilizing light reflective characteristics to determine alignment characteristics in time after illuminating. However, an application of the method is limited to substrate types, and =measurable to some types.

### SUMMARY

The present invention mainly solving technical problem is to provide a photo-alignment characteristics testing method, a device and a system, and to apply polarized absorption spectra at operation detections during panel manufacturing process to solve a technical problem of limited substrate types to detecting methods.

To solve aforementioned technical problem, another technical program is: providing a photo alignment characteristics testing method, wherein, the method comprises: forming a optical combination comprising a first optical device and a second optical device, the first optical device comprises at least a polarizer film, and the second optical device is a pre-tested material with a photocurabled alignment film disposed in; changing an included angle between an optical axis of the polarizer film in the first optical device and an optical axis of the alignment film in the second optical device simultaneously by lighting through the optical combination; and measuring light after lighting through the optical combination to obtain light intensities from different included angle situations and then to obtain photo-alignment characteristics of the alignment film.

Wherein, steps of forming the optical combination comprising the first optical device and the second optical device comprises: confirming polarizer film amount comprised in the first optical device, optical axis relationships between every polarizer films, and optical position relationships between every polarizer films and the second optical device according to a type of the pre-tested material.

Wherein, steps of confirming polarizer film amount comprised in the first optical device, optical axis relationships between every polarizer films, and optical position relationships between every polarizer films and the second optical device according to the type of the pre-tested material comprise: when a substrate with the photocurabled alignment film is disposed in the pre-tested material, a piece of polarizer film comprised in the first optical device is comfirmed correspondingly, and also the polarizer film located at the substrate facing forwards or away from the light direction is confirmed.

Wherein, a substrate with the photocurabled alignment film coated with polyimide film PI disposed on is a mother glass substrate, an array glass substrate or a colorful filter substrate.

Wherein, the steps of confirming polarizer film amount comprised in the first optical device, optical axis relationships between every polarizer films, and optical position relationships between every polarizer films and the second optical device according to the type of the pre-tested material comprise: a substrate with the photocurabled alignment film is disposed in the pre-tested material, two pieces of polarizer films comprised in the first optical device are comfirmed correspondingly, and also the polarizer film located at the substrate facing forwards or away from the light direction is confirmed, wherein, the light axises of the two pieces polarizer films are parallel to each other.

Wherein, a substrate with the photocurabled alignment film coated with polyimide film PI disposed on is a mother-glass substrate, an array glass substrate or a colorful filter substrate.

Wherein, the steps of confirming polarizer film amount comprised in the first optical device, optical axis relationships between every polarizer films, and optical position relationships between every polarizer films and the second optical device according to the type of the pre-tested material comprises: a substrate with the photocurabled alignment film is disposed in the pre-tested material, two pieces of polarizer films comprised in the first optical device are comfirmed correspondingly, and also the polarizer film located at the substrate facing forwards or away from the light direction is confirmed, wherein, the light axises of the two pieces polarizer films are perpendicular to each other.

Wherein, the substrate with the photocurabled alignment film disposed on is a post-celling liquid crystal substrate.

To solve the aforementioned technical problem, another technical program applied in the present invention is: providing a photo alignment characteristics testing device, wherein, the device comprises: a first optical device, comprising at least a polarizer film; a second optical device, which is a pre-tested material with a photocurabled alignment film disposed in; a light source, used in illuminating a optical combination formed by the first optical device and the second optical device, and an included angle between an optical axis of the polarizer film in the first optical device and an optical axis of the alignment film in the second optical device simultaneously change to lighting through the optical combination; and a light detector is used in measuring light after lighting through the optical combination to obtain light intensities from different included angle situations, and the light intensities are used in comfirming photo-alignment characteristics of the alignment film.

Wherein, the pre-tested material comprises a substrate with first area and a second area, wherein, the first area is a mother glass substrate coated with PI, the second substrate is an array glass substrate or a colorful filter substrate with a photocurabled alignment film disposed on.

To solve the aforementioned technical problem, another technical program applied in the present invention is: providing a photo alignment characteristics testing system, and the system comprises a photo alignment characteristics testing device and a photo alignment characteristics processing apparatus; the photo alignment characteristics testing device comprises: a first optical device, comprising at least a polarizer film; a second optical device, which is a pre-tested material with a photocurabled alignment film disposed on; a light source, used in illuminating a optical combination formed by the first optical device and the second optical device, and an included angle between an optical axis of the polarizer film in the first optical device and an optical axis of the alignment film in the second optical device simultaneously change to lighting through the optical combination; and a light detector, used in measuring light after passing through the optical combination to obtain light intensities from different included angle situations; the photo alignment characteristics testing device is used in light intensities obtaining from different included angles situations according to the light detector to confirming photo-alignment characteristics of the alignment film.

The advantageous effects of the invention are: the situation is different from the prior art, and the present invention provides a photo-alignment characteristics testing method, a device and a system to confirm polarizer film amount comprised in the first optical device, optical axis relationships between every polarizer films, and optical position relationships between every polarizer films and the second optical device according to the pre-tested material, and to change an included angle between an optical axis of the polarizer film in the first optical device and an optical axis of the alignment film in the second optical device by lighting through the optical combination to measure photo alignment characteristics of alignment films according to the light intensities by lighting through the optical combination and the corresponding included angles. By utilizing the present invention, a optical device can be directly chose for detection according to the pre-test material at operation detections, and corresponding photo alignment characteristics can be measured by polarized absorption of testing light without limitation of substrate types of pre-tested materials, and with increasing testing efficiency and production effect.

### BRIEF DESCRIPTION OF THE DRAWING

FIG. 1 is a flowchart schematic diagram of a photo-alignment characteristics testing method in the first embodiment of the present invention;

FIG. 2 is a flowchart schematic diagram of a photo-alignment characteristics testing method in the second embodiment in the present invention;

FIG. 3 is a schematic diagram of an optical combination of an embodiment in the present invention;

FIG. 4 is a schematic diagram of another optical combination of an embodiment in the present invention;

FIG. 5 is a schematic diagram of an optical combination of a further embodiment in the present invention;

FIG. 6 is a structural schematic diagram of a photo-alignment characteristics testing device of an embodiment in the present invention;

FIG. 7 is a structural schematic diagram of a photo-alignment characteristics testing system of an embodiment in the present invention;

FIG. 8 is a schematic diagram shows relationships between linear polarized light absorption and an included angle which is between a light axis of P polarizer film and a light axis of PI alignment film;

FIG. 9 is a schematic diagram showing alignment characteristics of photo-alignment PI materials at different anneal temperatures in one embodiment method of the present invention;

FIG. 10 is a schematic diagram showing a relationship between linear polarized light absorption and an included angle which is between a light axis of a polarizer film and a light axis of an alignment film of a celling liquid crystal;

FIG. 11 is a schematic diagram showing alignment characteristics of photo-alignment PI materials at different anneal temperatures in one embodiment method of the present invention.

### DETAILED DESCRIPTION OF THE EMBODIMENTS

Hereinafter, detailed descriptions will be set forth for the invention in conjunction with the accompanying drawings and embodiments.

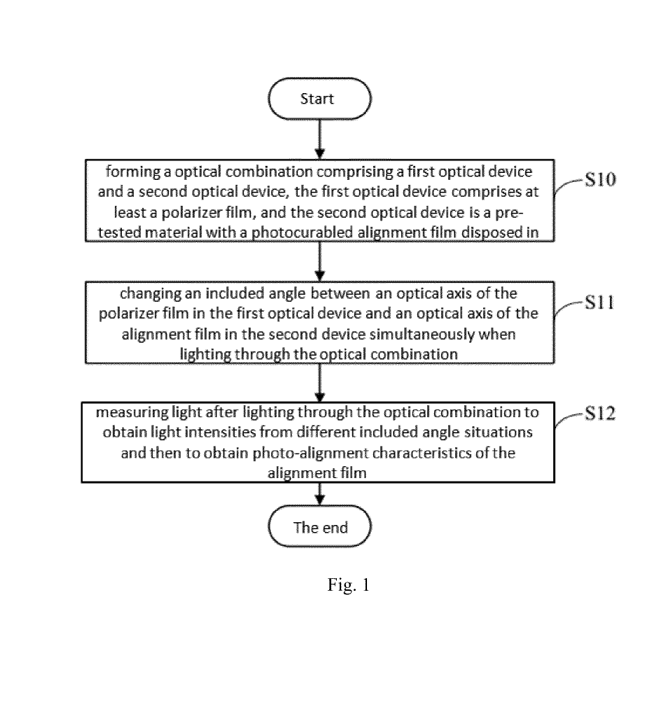

Please refer to FIG. 1, which is a flowchart schematic diagram of a photo-alignment characteristics testing method in the first embodiment of the present invention. A photo alignment characteristics testing method shown in the embodiment comprises steps as following:
step S10, forming a optical combination comprising a first optical device and a second optical device, the first optical device comprises at least a polarizer film, and the second optical device is a pre-tested material with a photocurabled alignment film disposed in.

Step S11, changing an included angle between an optical axis of the polarizer film in the first optical device and an optical axis of the alignment film in the second optical device simultaneously when lighting through the optical combination.

Step S12, measuring light after lighting through the optical combination to obtain light intensities from different included angle situations and then to obtain photo-alignment characteristics of the alignment film.

A pre-tested material of photocurabled alignment film disposed in has an anisotropy characteristic to have different linear polarized light absorption/transmission performance of different directions. For example, polyimide film PI materials is isotropy and has no direction choices for linear polarized light absorption. After photo alignment processing, photochemical reactions occurred to PI materials with orderedly distributed molecules and anisotropy. Only when linear polarized light and the molecular long axis direction is parallel, the materials produce largest absorption. Therefore, angles of photo alignment can be confirmed by checking polarizer angles corresponded with absorption peaks.

Particularly, to have light passed through by rotating polarizer film or the pre-tested material and to measure the light after passing through the optical combination can confirm the maximum light intensity and the minimum light intensity correspondingly. Wherein, corresponding parameters to measure the photo alignment characteristics of the pre-tested materials can be chose from the maximum light intensity, the minimum light intensity, an included angle corresponded by the maximum light intensity, an included angle corresponded by the minimum light intensity and a reference alignment angle; the photo alignment characteristics can comprise an alignment angle, an alignment performance, an alignment uniformity of film surfaces and etc. Wherein, both the reference alignment angle and the same qualified material alignment angle of the pre-tested material are known values. For example, comfirming photo alignment power by counting dichromic ratio, and counting photo alignment angles via included angles corresponded by the maximum light intensity or the minimum light intensity.

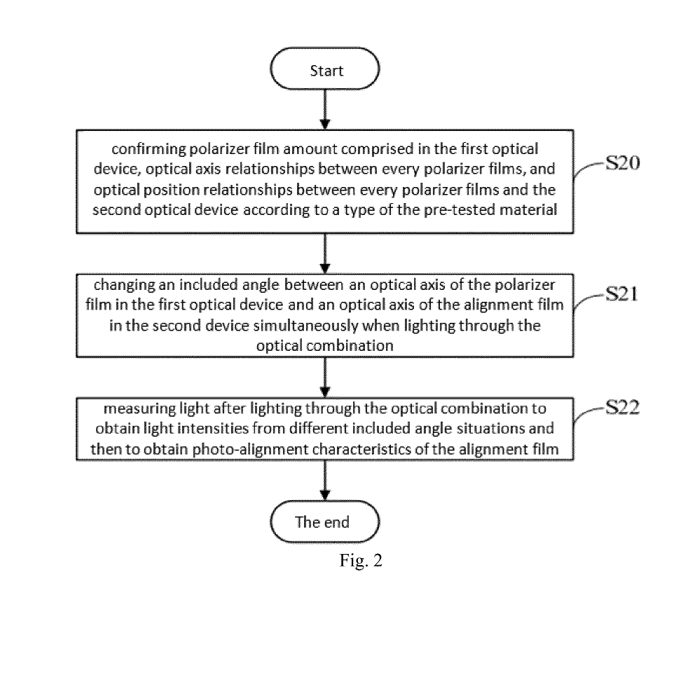

Please refer to FIG. 2, which is a flowchart schematic diagram of a photo-alignment characteristics testing method in the second embodiment in the present invention. A photo alignment characteristics testing method shown in the embodiment comprises steps as following:

step S20, confirming polarizer film amount comprised in the first optical device, optical axis relationships between every polarizer films, and optical position relationships between every polarizer films and the second optical device according to a type of the pre-tested material to form a optical combination comprising a first optical device and a second optical device.

Wherein, the first optical device comprises at least a polarizer film, and the second optical device, which is a pre-tested material with a photocurabled alignment film disposed in.

Wherein, the pre-tested material is a substrate with the photocurabled alignment film disposed in.

Step S21, changing an included angle between an optical axis of the polarizer film in the first optical device and an optical axis of the alignment film in the second optical device simultaneously when lighting through the optical combination.

Step S22, measuring light after lighting through the optical combination to obtain light intensities from different included angle situations and then to obtain photo-alignment characteristics of the alignment film.

Furthermore, when the substrate with the photocurabled alignment film coated with polyimide film PI disposed on is a mother glass substrate, an array glass substrate or a colorful filter substrate, in one embodiment, a piece of polarizer film comprised in the first optical device is comfirmed correspondingly according to the type of the pre-tested material, and also the polarizer film located at the substrate facing forward or away from the light direction is confirmed.

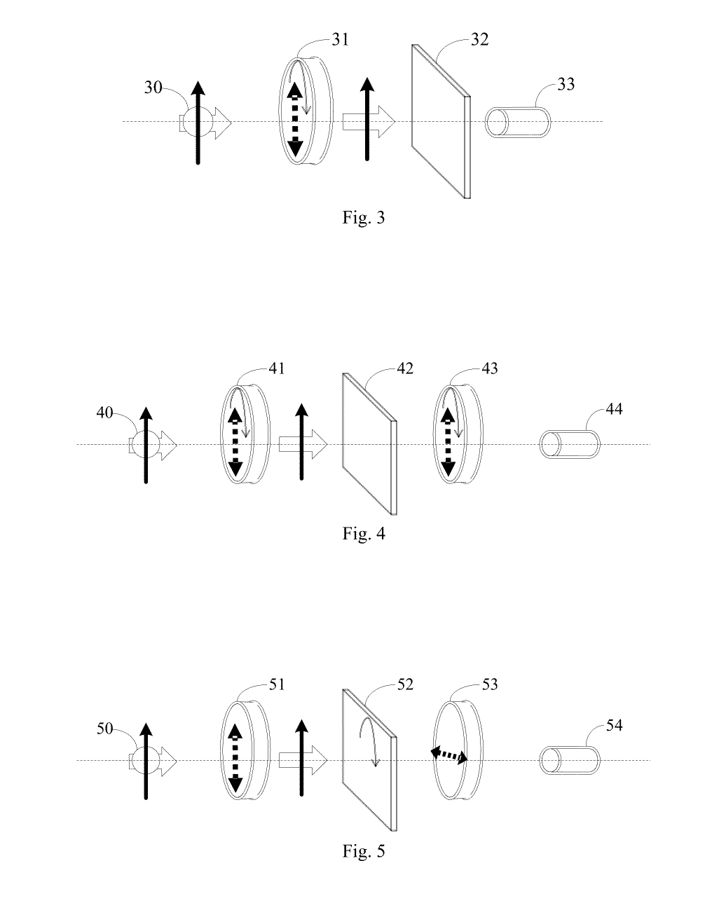

Please simultaneously refer to FIG. 3, which is a schematic diagram of an optical combination of an embodiment in the present invention. In the embodiment, the polarizer film is disposed between a light source 31 and a pre-tested material 32, and a light detector 33 is located at a side of the pre-tested material 32 away from the polarizer film 31. When the light source 30 illuminates the optical combination, an included angle between the optical axis and an optical axis of the alignment film of the pre-tested material 32 can be changed by rotating the polarizer film 31; the light passes through the polarizer film 31 and the pre-tested material 32 in order, and then the passing light is received by the light detector 33 to detect light intensities from different situations of included angles between the optical axis of the polarizer film 31 and the optical axis of an alignment film of the pre-tested material 32.

In another embodiment, according to a type of the pre-tested material and then that two pieces of polarizer films comprised in the first optical device is comfirmed correspondingly, and also the polarizer film located at the substrate facing forwards or away from the light direction is confirmed, wherein, the light axises of the two pieces polarizer films are parallel to each other.

Please simultaneously refer to FIG. 4, which is a schematic diagram of another optical combination of an embodiment in the present invention. In another embodiment, the pre-tested material 42 is located between a polarizer film 41 and a polarizer film 43, and a light source 40 is located at a side of the polarizer film 41 away from the pre-tested material 42, a light detector 44 is located at a side of the polarizer film 43 away from the pre-tested material 42. In addition, two light axises of both the polarizer film 41 and the polarizer film 43 are parallel at initial status. When the light source 40 illuminates the optical combination, an included angle between the optical axises of the polarizer films and an optical axis of the alignment film of the pre-tested material 42 can be changed by rotating the polarizer film 41 and the polarizer film 43; the light passes through the polarizer film 41, the pre-tested material 42 and the polarizer film 43 in order, and then the passing light is received by the light detector 44 to detect light intensities at different situations of included angles between the optical axises of the polarizer film 41 and the polarizer film 43 and the optical axis of an alignment film of the pre-tested material 42. Wherein, the polarizer film 41 and the polarizer film 43 are rotating at the same time and the rotating angles are the same.

Furthermore, when a substrate with the photocurabled alignment film disposed in turns into post-celling liquid-crystal substrate, in the embodiment, according to a type of the pre-tested material and then that two pieces of polarizer films comprised in the first optical device is comfirmed correspondingly, and also the polarizer film located at the substrate facing forwards or away from the light direction is confirmed, wherein, the light axises of the two pieces polarizer films are perpendicular to each other.

Please simultaneously refer to FIG. 5, which is a schematic diagram of an optical combination of a further embodiment in the present invention. In the further embodiment, the pre-tested material 52 is located between a polarizer film 51 and a polarizer film 53, and a light source 50 is located at a side of the polarizer film 51 away from the pre-tested material 52, a light detector 55 is located at a side of the polarizer film 53 away from the pre-tested material 52. In addition, two light axises of both the polarizer film 51 and the polarizer film 53 are perpendicular at initial status. When the light source 50 illuminates the optical combination, an included angle between the optical axises of the polarizer films 51 and 53 and an optical axis of the alignment film can be changed by rotating the pre-tested material 52, the light passes through the polarizer film 51, the pre-tested material 52 and the polarizer film 53 in order, and then the passing light is received by the light detector 55 to detect light intensities at different situations of included angles between the optical axises of the polarizer film 51 and the polarizer film 53 and the optical axis of an alignment film of the pre-tested material 52. In other embodiments, an included angle between the optical axises of the polarizer films and an optical axis of the alignment film of the pre-tested material 52 can be changed further by rotating the polarizer film 51 and the polarizer film 53. Wherein, the polarizer film 51 and the polarizer film 53 are rotating at the same time and the rotating angles are the same.

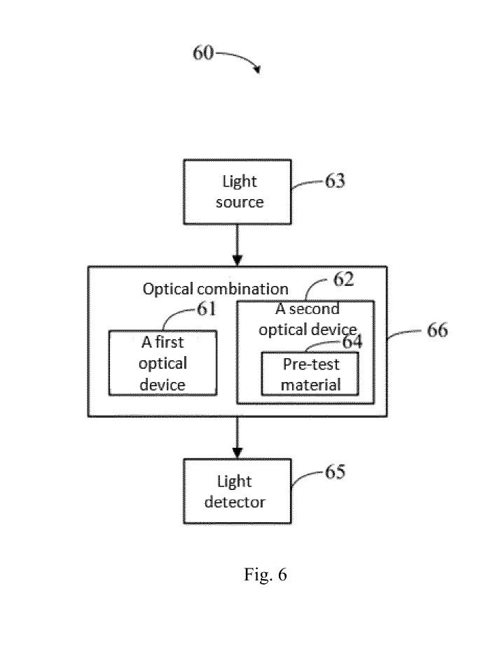

Please refer to FIG. 6, which is a structural schematic diagram of a photo-alignment characteristics testing device of an embodiment in the present invention. The device 60 comprises:

a first optical device 61, comprising at least a polarizer film;
a second optical device 62, which is a pre-tested material 64 with a photocurabled alignment film disposed in.

A light source 63, used in illuminating a optical combination 66 formed by the first optical device 61 and the second optical device 62, and an included angle between an optical axis of the polarizer film in the first optical device 61 and an optical axis of the alignment film in the second optical device 62 can be simultaneously change to lighting through the optical combination 66.

A light detector 65 is used in measuring light after lighting through the optical combination to obtain light intensities from different included angle situations, and the light intensities are used in comfirming photo-alignment characteristics of the alignment film.

Position connecting relationships of every elements devices and units comprised in the photo-alignment characteristics testing device in the present invention is not limited to what shown in drawings, and the drawings are for schematic drawings only, and not for limited hereto.

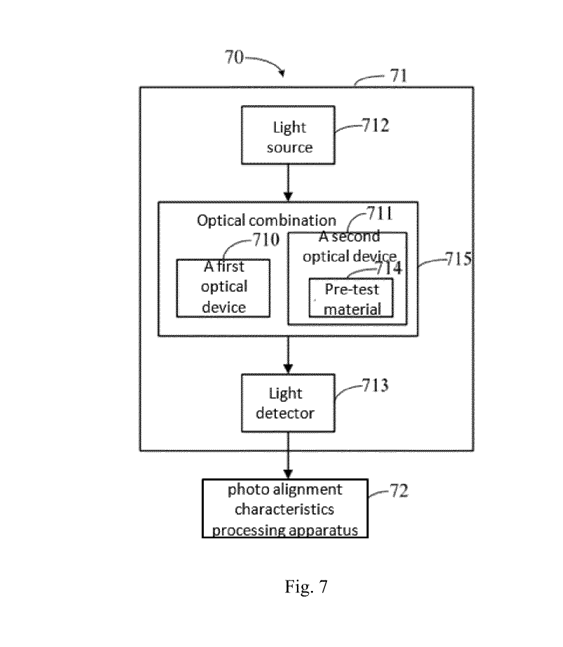

Please refer to FIG. 7, which is a structural schematic diagram of a photo-alignment characteristics testing system of an embodiment in the present invention. The system 70 comprises a photo alignment characteristics testing device 71 and a photo alignment characteristics processing apparatus 72; the photo alignment characteristics testing device 71 comprises:

a first optical device 710, comprising at least a polarizer film.

A second optical device 711, which is a pre-tested material 714 with a photocurabled alignment film disposed in;

A light source 712, used in illuminating a optical combination 715 formed by the first optical device 710 and the second optical device 711, and an included angle between an optical axis of the polarizer film in the first optical device 710 and an optical axis of the alignment film in the second optical device 711 can be simultaneously change to lighting through the optical combination.

A light detector 713, used in measuring light after passing through the optical combination 715 to obtain light intensities from different included angle situations;

The photo alignment characteristics testing device 71 is used in light intensities obtaining from different included angles situations according to the light detector 713 to confirming photo-alignment characteristics of the alignment film.

Wherein, the first optical device 710 can continue comprised polarizer film amount, optical axis relationships between every polarizer films, and optical position relationships between every polarizer films and the second optical device 711 according to a type of the pre-tested material 714.

The type of the pre-tested material 714 is a substrate with a photocurabled alignment film disposed on.

When the substrate with the photocurabled alignment film coated with polyimide film PI disposed on is a mother glass substrate, an array glass substrate or a colorful filter substrate, in one embodiment, a piece of polarizer film comprised in the first optical device 710 is comfirmed correspondingly according to the type of the pre-tested material 714, and also the polarizer film located at the substrate facing forward or away from the light source 712 direction is confirmed. A particular position relationship is shown as FIG. 3. In another embodiment, two pieces of polarizer films comprised in the first optical device 710 is comfirmed correspondingly according to the type of the pre-tested material 714, and also the polarizer film located at the substrate facing forward or away from the light source 712 direction is confirmed. A particular position relationship is shown as FIG. 4.

When a substrate with the photocurabled alignment film disposed in turns into post-celling liquid-crystal substrate, in the embodiment, according to a type of the pre-tested material 714, the first optical device 710 comprises two pieces of polarizer films is comfirmed correspondingly, and also the polarizer film located at the substrate facing forwards or away from the light source 712 direction is confirmed. wherein, the light axises of the two pieces polarizer films are perpendicular to each other. A particular position relationship is shown as FIG. 5.

Furthermore, the light detector 713 correspondingly confirms the maximum light intensity and the minimum light intensity by measuring light passing through the optical combination. The photo alignment characteristics processing apparatus 72 confirms the maximum light intensity and the minimum light intensity from the light detector 713, obtains an included angle corresponded by the maximum light intensity, an included angle corresponded by the minimum light intensity and a reference alignment angle, can then calculates the photo alignment characteristics of the pre-tested material 714 based on these corresponding chosen parameters; the photo alignment characteristics can comprise an alignment angle, an alignment performance, an alignment uniformity of film surfaces and etc. Wherein, both the reference alignment angle and the same qualified material alignment angle of the pre-tested material are known values.

Furthermore, the pre-tested material 714 comprises a substrate with a first area and a second area, wherein, the first area is a mother glass substrate coated with PI, the second substrate is an array glass substrate or a colorful filter substrate with a photocurabled alignment film disposed on.

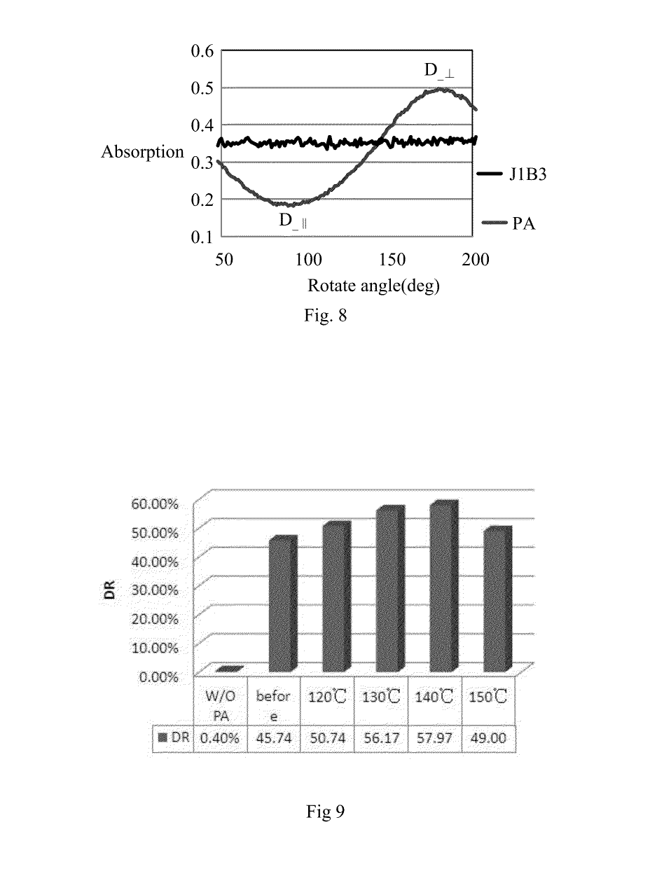

Please refer to FIG. 8 and FIG. 9 simultaneously, wherein, FIG. 8 is a schematic diagram shows relationships between linear polarized light absorption and an included angle which is between a light axis of P polarizer film and a light axis of PI alignment film, and FIG. 9 is a schematic diagram showing alignment characteristics of photo-alignment PI materials at different anneal (cool off) temperatures in one embodiment method of the present invention.

Wherein, PI film alignment characteristic is presented by dichromic ratio (DR), the formula is:

$$DR = \frac{{D}_{- ⊥} - {D}_{- ‖}}{{D}_{- ⊥} + {D}_{- ‖}}$$

In particular, when PI has no photo alignment, DR is close to 0; after alignment processing, DR increases to 40%; alignment characteristics improve under control of a different anneal temperature operation; DR value is increasing with increasing temperature, and when anneal is 140° C., DR value is the largest.

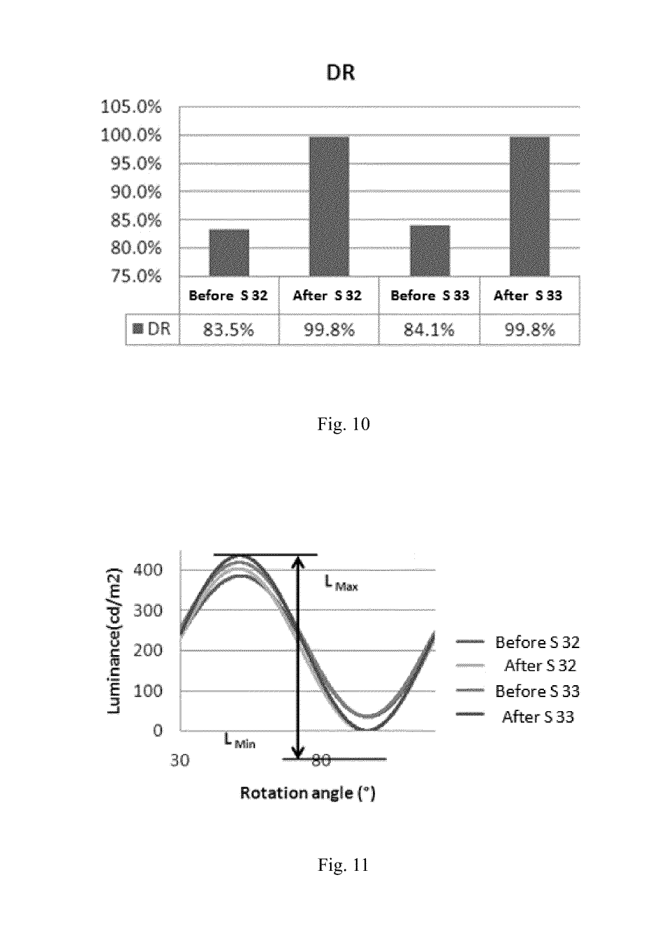

Please refer to FIG. 10 and FIG. 11 at the same time, wherein, FIG. 10 is a schematic diagram showing a relationship between linear polarized light absorption and an included angle which is between a light axis of a polarizer film and a light axis of an alignment film of a celling liquid crystal (Cell); and FIG. 11 is a schematic diagram showing alignment characteristics of photo-alignment PI materials at different anneal (cool off) temperatures in one embodiment method of the present invention.

Wherein, Cell alignment characteristic is presented by dichromic ratio (DR), the formula is:

$$DR = \frac{{L}_{ma x} - {L}_{m i n}}{{L}_{ma x} + {L}_{m i n}}$$

In particular, due to drop mura is occurred in Cell, DR<85%; after an anneal operation, liquid crystal alignment characteristics improve and DR value increases to larger than 99%. Therefor, cell alignment characteristics can be determined by calculating DR.

The present invention provides a photo-alignment characteristics testing method, a device and a system, to confirm polarizer film amount comprised in a first optical device, optical axis relationships between every polarizer films, and optical position relationships between every polarizer films and a second optical device according to a type of a pre-tested material, and to change an included angle between an optical axis of the polarizer film in the first optical device and an optical axis of the alignment film in the second optical device by lighting through the optical combination to measure photo alignment characteristics of alignment films according to the light intensities by lighting through the optical combination and the corresponding included angles. By utilizing the present invention, a optical device can be directly chose for detection according to the pre-test material at operation detections, and corresponding photo alignment characteristics can be measured by polarized absorption of testing light without limitation of substrate types of pre-tested materials, and with increasing testing efficiency and production effect. In the aforementioned embodiments, the present disclosure is only described in an illustrative manner. However, upon reading this patent application, those skilled in the art can make various modifications on the present disclosure without departing from the spirits and the scope of the present disclosure.

1. A photo alignment characteristics testing method, wherein, the method comprises:
forming a optical combination comprising a first optical device and a second optical device, the first optical device comprises at least a polarizer film, and the second optical device is a pre-tested material with a photocurabled alignment film disposed in;
changing an included angle between an optical axis of the polarizer film in the first optical device and an optical axis of the alignment film in the second optical device simultaneously when lighting through the optical combination; and
measuring light after lighting through the optical combination to obtain light intensities from different included angle situations and then to obtain photo-alignment characteristics of the alignment film.

2. The photo alignment characteristics testing method according to claim 1, wherein, steps of forming the optical combination comprising the first optical device and the second optical device comprises:
confirming polarizer film amount comprised in the first optical device, optical axis relationships between every polarizer films, and optical position relationships between every polarizer films and the second optical device according to a type of the pre-tested material.

3. The photo alignment characteristics testing method according to claim 2, wherein, steps of confirming polarizer film amount comprised in the first optical device, optical axis relationships between every polarizer films, and optical position relationships between every polarizer films and the second optical device according to the type of the pre-tested material comprise:
when a substrate with the photocurabled alignment film is disposed in the pre-tested material, a piece of polarizer film comprised in the first optical device is comfirmed correspondingly, and also the polarizer film located at the substrate facing forwards or away from the light direction is confirmed.

4. The photo alignment characteristics testing method according to claim 3, wherein, the substrate with the photocurabled alignment film coated with polyimide film PI disposed on is a mother glass substrate, an array glass substrate or a colorful filter substrate.

5. The photo alignment characteristics testing method according to claim 2, wherein, the steps of confirming polarizer film amount comprised in the first optical device, optical axis relationships between every polarizer films, and optical position relationships between every polarizer films and the second optical device according to the type of the pre-tested material comprise:
a type of the pre-tested material is a substrate with the photocurabled alignment film disposed in, two pieces of polarizer films comprised in the first optical device are comfirmed correspondingly, and also the polarizer film located at the substrate facing forwards or away from the light direction is confirmed, wherein, the light axises of the two pieces polarizer films are parallel to each other.

6. The photo alignment characteristics testing method according to claim 5, wherein, a substrate with the photocurabled alignment film disposed on is a mother-glass substrate, an array glass substrate or a colorful filter substrate with coated polyimide film PI.

7. The photo alignment characteristics testing method according to claim 2, wherein, the steps of confirming polarizer film amount comprised in the first optical device, optical axis relationships between every polarizer films, and optical position relationships between every polarizer films and the second optical device according to the type of the pre-tested material comprises:
a substrate with the photocurabled alignment film is disposed in the pre-tested material, two pieces of polarizer films comprised in the first optical device are comfirmed correspondingly, and also the polarizer film located at the substrate facing forwards or away from the light direction is confirmed, wherein, the light axises of the two pieces polarizer films are perpendicular to each other.

8. The photo alignment characteristics testing method according to claim 7, wherein, the substrate with the photocurabled alignment film disposed on is a post-celling liquid crystal substrate.

9. A photo alignment characteristics testing device, wherein, the device comprises:
a first optical device, comprising at least a polarizer film;
a second optical device, which is a pre-tested material with a photocurabled alignment film disposed in;
a light source, used in illuminating a optical combination formed by the first optical device and the second optical device, and an included angle between an optical axis of the polarizer film in the first optical device and an optical axis of the alignment film in the second optical device simultaneously change to lighting through the optical combination; and a light detector is used in measuring light after lighting through the optical combination to obtain light intensities from different included angle situations, and the light intensities are used in comfirming photo-alignment characteristics of the alignment film.

10. The photo alignment characteristics testing device according to claim 9, wherein, the pre-tested material comprises a substrate with a first area and a second area, wherein, the first area is a mother glass substrate coated with PI, the second substrate is an array glass substrate or a colorful filter substrate with a photocurabled alignment film disposed on.

11. A photo alignment characteristics testing system, wherein, the system comprises a photo alignment characteristics testing device and a photo alignment characteristics processing apparatus; the photo alignment characteristics testing device comprises:
a first optical device, comprising at least a polarizer film;
a second optical device, which is a pre-tested material with a photocurabled alignment film disposed in;
a light source, used in illuminating a optical combination formed by the first optical device and the second optical device, and an included angle between an optical axis of the polarizer film in the first optical device and an optical axis of the alignment film in the second optical device simultaneously change to lighting through the optical combination; and
a light detector, used in measuring light after passing through the optical combination to obtain light intensities from different included angle situations;
the photo alignment characteristics testing device is used in light intensities obtaining from different included angles situations according to the light detector to confirming photo-alignment characteristics of the alignment film.

12. (canceled)
